(19) United States
(12) Patent Application Publication
(10) Pub. No.: US 2025/0061359 A1
(43) Pub. Date: Feb. 20, 2025

(54) CLIFFORD CIRCUIT FORECASTING WITHOUT FORWARD FAULT PROPAGATION

(71) Applicant: Microsoft Technology Licensing, LLC, Redmond, WA (US)

(72) Inventors: Nicolas Guillaume DELFOSSE, Seattle, WA (US); Adam Edward PAETZNICK, Bellevue, WA (US)

(73) Assignee: Microsoft Technology Licensing, LLC, Redmond, WA (US)

(21) Appl. No.: 18/449,260

(22) Filed: Aug. 14, 2023

(51) Int. Cl. G06N 10/20; G06N 10/70

(52) U.S. Cl. CPC G06N 10/20; G06N 10/70

(57) ABSTRACT

A method to forecast the result of a Clifford circuit acting on the qubits comprises: for a fault operator F acting on the qubits, precomputing a backward cumulant [symbol] of the fault operator for each row u of binary matrices Mₛ and Mₗ, the backward cumulant reflecting an effect f=effₘ(F) on measurement outcomes of the qubits according to the Clifford circuit and fault operator; sampling the fault operator F for the qubits according to the predetermined noise distribution in the Clifford circuit; computing a syndrome s=Mₛf corresponding to the effect based on a commutator of the backward cumulant [symbol] versus a row of the binary matrix Mₛ; computing a set of logical flips f̅=Mₗf corresponding to the effect based on a commutator of the backward cumulant [symbol] versus a row of the binary matrix Mₗ; and returning the result based on the syndrome and on the set of logical flips.

### BACKGROUND

A quantum computer is a physical machine configured to execute logical operations based on quantum-mechanical phenomena. Such logical operations may include, for example, mathematical computation. Current interest in quantum-computer technology is motivated by analysis suggesting that the computational efficiency of an appropriately configured quantum computer may surpass that of any practicable non-quantum computer when applied to certain types of problems. Such problems include computer modeling of natural and synthetic quantum systems, integer factorization, data searching, and function optimization as applied to systems of linear equations and machine learning.

### SUMMARY

One aspect of this disclosure relates to a method to forecast the result of a Clifford circuit acting on a plurality of qubits of a quantum computer, the Clifford circuit being subject to noise. The method comprises (a) for a fault operator F acting on the plurality of qubits according to a predetermined noise distribution, precomputing a backward cumulant [symbol] of the fault operator for each row u of binary matrices Mₛ and Mₗ, the backward cumulant reflecting an effect f=effₘ(F) on measurement outcomes of the plurality of qubits according to the Clifford circuit and the fault operator; (b) sampling the fault operator F for the plurality of qubits according to the predetermined noise distribution in the Clifford circuit; (c) computing a syndrome s=Mₛf corresponding to the effect based on a commutator of the backward cumulant [symbol] versus a row of the binary matrix Mₛ; (d) computing a set of logical flips f̅=Mₗf corresponding to the effect based on a commutator of the backward cumulant [symbol] versus a row of the binary matrix Mₗ; and (e) returning the result based on the syndrome and on the set of logical flips.

Another aspect of this disclosure relates to a quantum computer quantum computer comprising a qubit register with a plurality of physical qubits; an interface configured to measure each of the plurality of qubits, to thereby reveal a quantum state held in the qubit register; and a controller. The controller is coupled operatively to the interface and configured to direct the measurement according to a spacetime quantum code supporting quantum error correction, the spacetime quantum code qualified by: (a) for a fault operator F acting on the plurality of qubits according to a predetermined noise distribution, precomputing a backward cumulant [symbol] of the fault operator for each row u of binary matrices Mₛ and Mₗ, the backward cumulant reflecting an effect f=effₘ(F) on measurement outcomes of the plurality of qubits according to the Clifford circuit and the fault operator, (b) sampling the fault operator F for the plurality of qubits according to the predetermined noise distribution in the Clifford circuit, (c) computing a syndrome s=Mₛf corresponding to the effect based on a commutator of the backward cumulant [symbol] versus a row of the binary matrix Mₛ, (d) computing a set of logical flips f̅=Mₗf corresponding to the effect based on a commutator of the backward cumulant [symbol] versus a row of the binary matrix Mₗ, and (e) returning the result based on the syndrome and on the set of logical flips.

Another aspect of this disclosure relates to method for operating a quantum computer. The method comprises supplying an error-correcting spacetime code to a controller coupled operatively to a qubit interface of the quantum computer, the spacetime code being qualified by: (a) for a fault operator F acting on the plurality of qubits according to a predetermined noise distribution, precomputing a backward cumulant [symbol] of the fault operator for each row u of binary matrices Mₛ and Mₗ, the backward cumulant reflecting an effect f=effₘ(F) on measurement outcomes of the plurality of qubits according to the Clifford circuit and the fault operator, (b) sampling the fault operator F for the plurality of qubits according to the predetermined noise distribution in the Clifford circuit, (c) computing a syndrome s=Mₛf corresponding to the effect based on a commutator of the backward cumulant [symbol] versus a row of the binary matrix Mₛ, (d) computing a set of logical flips f̅=Mₗf corresponding to the effect based on a commutator of the backward cumulant [symbol] versus a row of the binary matrix Mₗ, and (e) returning the result based on the syndrome and on the set of logical flips.

This Summary is provided to introduce in simplified form a selection of concepts that are further described in the Detailed Description. This Summary is not intended to identify key features or essential features of the claimed subject matter, nor is it intended to be used to limit the scope of the claimed subject matter. The claimed subject matter is not limited to implementations that solve any or all disadvantages noted in any part of this disclosure.

### BRIEF DESCRIPTION OF THE DRAWINGS

FIG. 1 shows aspects of an example quantum computer.

FIG. 2 illustrates a Bloch sphere, which graphically represents the quantum state of one qubit of a quantum computer.

FIG. 3 shows aspects of an example signal waveform for effecting a quantum-gate operation or measurement in a quantum computer.

FIG. 4 is a high-level illustration of a comparative method for estimating the performance of a Clifford circuit.

FIG. 5 is a high-level illustration of a comparative method for simulating a Clifford circuit subject to circuit noise.

FIG. 6 is a table illustrating the worst-case computational complexity of the main steps of circuit-noise simulation for different classes of circuits and different simulation strategies.

FIG. 7 shows aspects of an example method to forecast a result of a Clifford circuit acting on a plurality of qubits of a quantum computer, where the Clifford circuit is subject to noise.

FIG. 8 shows aspects of an example classical computer system, such a quantum-error-correction simulator or a quantum-computer controller.

### DETAILED DESCRIPTION

### 1. Overview

As described in further detail herein, the design and optimization of an error-detecting and/or error-correcting quantum computer relies heavily on numerical simulation to assess the performance of each component. Simulation of quantum ‘gadgets’ configured for error detection and/or correction, which are typically implemented by Clifford circuits, can be done by sampling circuit faults and propagating them forward through the circuit to verify that they do not corrupt the logical data. One may have to repeat the forward fault propagation trillions of times to compute an accurate estimate of the performance of a quantum gadget. In this disclosure, an alternative simulation algorithm is proposed which does not require forward fault propagation but instead exploits the mathematical structure of the spacetime code corresponding to the circuit. More specifically, Proposition 3 from [Ref. 1] is used to replace the forward propagation of trillions of fault configurations by backward propagation of a small number of Pauli operators, which can be precomputed once and for all.

### 2. Quantum-Computer Architecture

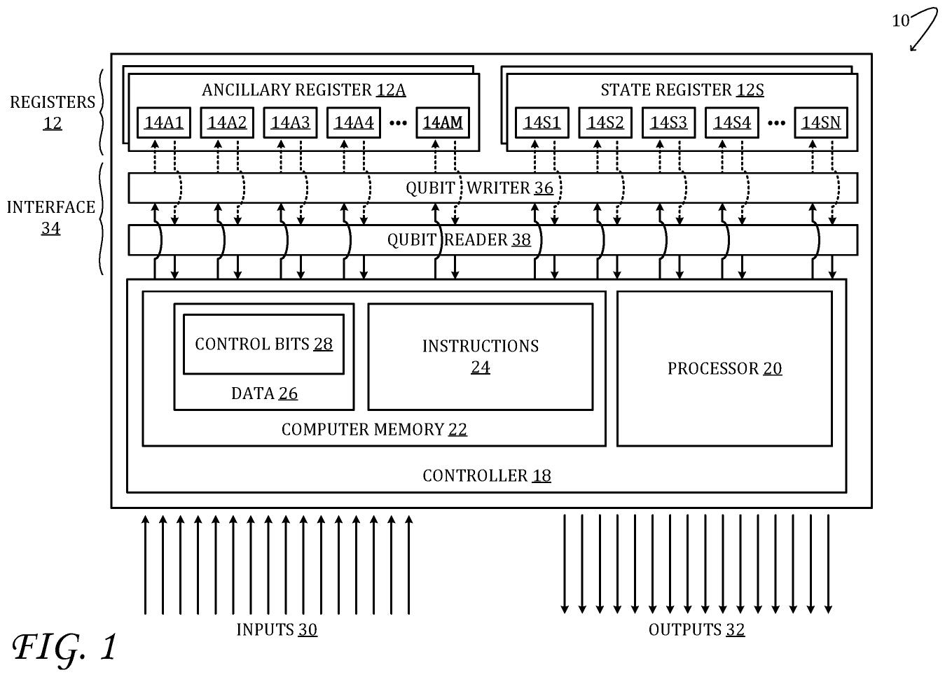

In order to provide a context for quantum error detection and correction without forward fault propagation, some aspects of an example quantum-computer architecture will first be described. Turning now to the drawings, FIG. 1 shows aspects of an example quantum computer 10 configured to execute quantum-logic operations (vide infra). Whereas conventional computer memory holds digital data in an array of bits and enacts bit-wise logic operations, a quantum computer holds data in an array of qubits and operates quantum-mechanically on the qubits in order to implement the desired logic. Accordingly, quantum computer 10 of FIG. 1 includes a set of qubit registers 12—e.g., state register 12S and auxiliary register 12A. Each qubit register includes a series of qubits 14. The number of qubits in a qubit register is not particularly limited but may be determined based on the complexity of the quantum logic to be enacted by the quantum computer.

Qubits 14 of qubit register 12 may take various forms, depending on the desired architecture of quantum computer 10. Each qubit may comprise: a superconducting Josephson junction, a trapped ion, a trapped atom coupled to a high-finesse cavity, an atom or molecule confined within a fullerene, an ion or neutral dopant atom confined within a host lattice, a quantum dot exhibiting discrete spatial- or spin-electronic states, electron holes in semiconductor junctions entrained via an electrostatic trap, a coupled quantum-wire pair, an atomic nucleus addressable by magnetic resonance, a free electron in helium, a molecular magnet, or a metal-like carbon nanosphere, as non-limiting examples. A qubit may be implemented in the plural processing states corresponding to different modes of light propagation through linear optical elements (e.g., mirrors, beam splitters and phase shifters), as well as in states accumulated within a Bose-Einstein condensate. More generally, each qubit 14 may comprise any particle or system of particles that can exist in two or more discrete quantum states that can be measured and manipulated experimentally.

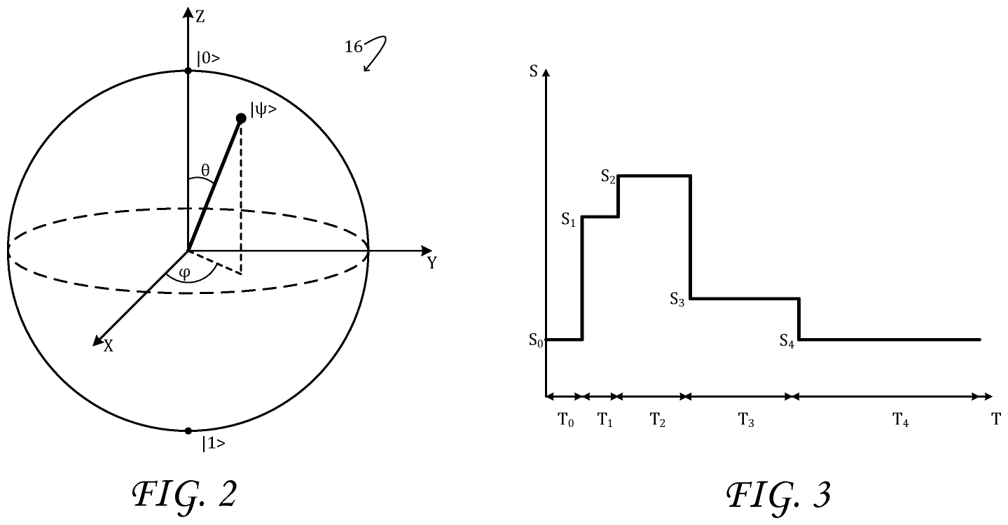

FIG. 2 is an illustration of a Bloch sphere 16, which provides a graphical description of some quantum mechanical aspects of an individual qubit 14. In this description, the north and south poles of the Bloch sphere correspond to the standard basis vectors |0 [symbol] and |1 [symbol] , respectively—up and down spin states, for example, of an electron or other fermion. The set of points on the surface of the Bloch sphere comprise all possible pure states |ψ [symbol] of the qubit, while the interior points correspond to all possible mixed states. A mixed state of a given qubit may result from decoherence, which may occur because of undesirable coupling to external degrees of freedom.

Returning now to FIG. 1, quantum computer 10 includes a controller 18. The controller may include at least one processor 20 and associated computer memory 22. Processor 20 may be coupled operatively to peripheral componentry, such as network componentry, to enable the quantum computer to be operated remotely. Processor 20 may take the form of a central processing unit (CPU), a graphics processing unit (GPU), or the like. As such, controller 18 may comprise classical electronic componentry. The terms ‘classical’ and ‘non-quantum’ are applied herein to any component that can be modeled accurately without considering the quantum state of any individual particle therein. Classical electronic components include integrated, microlithographed transistors, resistors, and capacitors, for example. Computer memory 22 may be configured to hold program instructions 24 that cause processor 20 to execute any function or process of controller 18. The computer memory may also be configured to hold additional data 26. In some examples, data 26 may include a register of classical control bits 28 that influence the operation of the quantum computer during run time—e.g., to provide classical control input to one or more quantum-gate operations. In examples in which qubit register 12 is a low-temperature or cryogenic device, controller 18 may include control componentry operable at low or cryogenic temperatures—e.g., a field-programmable gate array (FPGA) operated at 77K. In such examples, the low-temperature control componentry may be coupled operatively to interface componentry operable at normal temperatures.

Controller 18 of quantum computer 10 is configured to receive a plurality of inputs 30 and to provide a plurality of outputs 32. The inputs and outputs may each comprise digital and/or analog lines. At least some of the inputs and outputs may be data lines through which data is provided to and/or extracted from the quantum computer. Other inputs may comprise control lines via which the operation of the quantum computer may be adjusted or otherwise controlled.

Controller 18 is operatively coupled to qubit registers 12 via quantum interface 34. The quantum interface is configured to exchange data (solid lines) bidirectionally with the controller. The quantum interface is further configured to exchange signal associated with the data (dashed lines) bidirectionally with the qubit registers. Depending on the physical implementation of qubits 14, such signal may include electrical, magnetic, and/or optical signal. Via signal conveyed through the quantum interface, the controller may interrogate and otherwise influence the quantum state held in any, some, or all of the qubit registers, as defined by the collective quantum state of the qubits therein. To that end, the quantum interface includes qubit writer 36 and qubit reader 38. The qubit writer is configured to output a signal to one or more qubits of a qubit register based on write-data received from the controller. The qubit reader is configured to sense a signal from one or more qubits of a qubit register and to output read-data to the controller based on the signal. The read-data received from the qubit reader may, in some examples, be an estimate of an observable to the measurement of the quantum state held in a qubit register. Taken together, controller 18 and interface 34 may be referred to as a ‘control system’.

In some examples, suitably configured signal from qubit writer 36 may interact physically with one or more qubits 14 of a qubit register 12, to trigger measurement of the quantum state held in the one or more qubits. Qubit reader 38 may then sense a resulting signal released by the one or more qubits pursuant to the measurement, and may furnish read-data corresponding to the resulting signal to controller 18. Stated another way, the qubit reader may be configured to output, based on the signal received, an estimate of one or more observables reflecting the quantum state of one or more qubits of a qubit register, and to furnish the estimate to controller 18. In one non-limiting example, the qubit writer may provide, based on data from the controller, an appropriate voltage pulse or pulse train to an electrode of one or more qubits, to initiate a measurement. In short order, the qubit reader may sense photon emission from the one or more qubits and may assert a corresponding digital voltage level on a quantum-interface line into the controller. Generally speaking, any measurement of a quantum-mechanical state is defined by the operator O corresponding to the observable to be measured; the result R of the measurement is guaranteed to be one of the allowed eigenvalues of 0. In quantum computer 10, R is statistically related to the qubit-register state prior to the measurement, but is not uniquely determined by the qubit-register state.

Pursuant to appropriate input from controller 18, quantum interface 34 may be configured to implement one or more quantum-logic gates to operate on the quantum state held in a qubit register 12. The term ‘state vector’ refers herein to the quantum state held in the series of qubits 14S of state register 12S of quantum computer 10. Whereas the function of each type of logic gate of a classical computer system is described according to a corresponding truth table, the function of each type of quantum gate is described by a corresponding operator matrix. The operator matrix operates on (i.e., multiplies) the complex vector representing a qubit register state and effects a specified rotation of that vector in Hilbert space.

For example, the Hadamard gate H is defined by

$$H = \frac{1}{\sqrt{2}} [ \begin{matrix}1 & 1 \\ 1 & - 1\end{matrix} ] . \qquad ( 1 )$$

The H gate acts on a single qubit; it maps the basis state |0 [symbol] to (|0 [symbol] +|1 [symbol] )/\sqrt{2}, and maps |1 [symbol] to (|0 [symbol] −|1 [symbol] )/\sqrt{2}. Accordingly, the H gate creates a superposition of states that, when measured, have equal probability of revealing |0 [symbol] or |1 [symbol] .

The phase gate S is defined by

$$S = [ \begin{matrix}1 & 0 \\ 0 & {e}^{i π / 2}\end{matrix} ] . \qquad ( 2 )$$

The S gate leaves the basis state |0 [symbol] unchanged but maps |1 [symbol] to e^{iπ/2}|1 [symbol] . Accordingly, the probability of measuring either |0 [symbol] or |1 [symbol] is unchanged by this gate, but the phase of the quantum state of the qubit is shifted. This is equivalent to rotating |ψ [symbol] by 90 degrees along a circle of latitude on the Bloch sphere of FIG. 2.

Some quantum gates operate on two or more qubits. The SWAP gate, for example, acts on two distinct qubits and swaps their values. This gate is defined by

$$SWAP = [ \begin{matrix}1 & 0 & 0 & 0 \\ 0 & 0 & 1 & 0 \\ 0 & 1 & 0 & 0 \\ 0 & 0 & 0 & 1\end{matrix} ] . \qquad ( 3 )$$

A ‘Clifford gate’ is a quantum gate that belongs to the Clifford group—viz., a set of quantum gates that effect permutations of the Pauli operators. For the n-qubit case the Pauli operators form a group

$${P}_{n} = \{ {e}^{\frac{i θπ}{2}} {σ}_{{j}_{1}} ⊗ ⋯ ⊗ {σ}_{{j}_{n}} \vert θ = 0 , 1 , 2 , 3 , {j}_{k} = 0 , 1 , 2 , 3 \} , \qquad ( 4 )$$

where σ₀, . . . σ₃ are the single-qubit Pauli matrices. The Clifford group is then defined as the group of unitaries that normalize the Pauli group,

$${C}_{n} = \{ V ∈ {U}_{{2}^{n}} \vert {VP}_{n} {V}^{†} = {P}_{n} \} . \qquad ( 5 )$$

The foregoing list of quantum gates and associated operator matrices is non-exhaustive, but is provided for ease of illustration. Other quantum gates include Pauli—X, −Y, and −Z gates, the \sqrt{NOT} gate, additional phase-shift gates, the \sqrt{SWAP} gate, controlled cX, cY, and cZ gates, and the Toffoli, Fredkin, Ising, and Deutsch gates, as non-limiting examples.

Continuing in FIG. 1, suitably configured signal from qubit writer 36 of quantum interface 34 may interact physically with one or more qubits 14 of a qubit register 12 so as to assert any desired quantum-gate operation. As noted above, the desired quantum-gate operations include specifically defined rotations of a complex vector representing a qubit register state. In some examples, in order to effect a desired rotation O, the qubit writer may apply a predetermined signal level Sᵢ for a predetermined duration Tᵢ. In some examples, plural signal levels may be applied for plural sequenced or otherwise associated durations, as shown in FIG. 3, to assert a quantum-gate operation on one or more qubits of a qubit register. In general, each signal level Sᵢ and each duration Tᵢ is a control parameter adjustable by appropriate programming of controller 18.

The terms ‘quantum circuit’ and ‘quantum algorithm’ are used herein to describe a predetermined sequence of elementary quantum-gate and/or measurement operations executable by quantum computer 10. A quantum circuit may be used to transform the quantum state of a qubit register 12 to effect a classical or non-elementary quantum-gate operation or to apply a density operator, for example. In some examples, a quantum circuit may be used to enact a predefined operation f(x), which may be incorporated into a complex sequence of operations. To ensure adjoint operation, a quantum circuit mapping n input qubits |x [symbol] to m output or auxiliary qubits |y=f(x) [symbol] may be defined as a quantum gate O(|x [symbol] ⊗|y [symbol] ) operating on the (n+m) qubits. In this case, O may be configured to pass the n input qubits unchanged but combine the result of the operation f(x) with the auxiliary qubits via an XOR operation, such that O(|x [symbol] ⊗|y [symbol] )=|x [symbol] ⊗|y⊗(f(x) [symbol] .

Implicit in the description herein is that each qubit 14 of any qubit register 12 may be interrogated via quantum interface 34 so as to reveal with confidence the standard basis vector |0 [symbol] or |1 [symbol] that characterizes the quantum state of that qubit. In some implementations, however, measurement of the quantum state of a physical qubit may be subject to error. Accordingly, any qubit 14 may be implemented as a logical qubit, which includes a grouping of physical qubits measured according to an error-correcting quantum algorithm or circuit that reveals the quantum state of the logical qubit with above-threshold confidence.

### 3. Quantum Error Detection and Correction

At the core of the architecture of an error-detecting and/or error-correcting quantum computer is a qubit-redundancy code such as a surface code [Ref. 2][Ref. 3] or Floquet code [Ref. 4][Ref. 5][Ref. 6] implemented via a suitably configured Clifford circuit. A circuit may be specified for each logical operation of a quantum algorithm to enable error detection and/or correction. This may include, for instance, idle gates, lattice surgery, magic-state distillation and state-injection circuits. Optimizing all these circuits for a given type of qubit, gate set, connectivity and noise model uses computationally expensive numerical simulation on a classical computer.

A typical scenario is one in which a Clifford circuit implements an error detecting and/or error-correcting quantum gadget, and the objective is to estimate the failure rate of this gadget for different noise parameters. This disclosure considers the standard circuit-noise model [Ref. 2], where each circuit operation is followed by a random Pauli error acting on its support, such that the measurement outcomes are erroneously flipped with some probability.

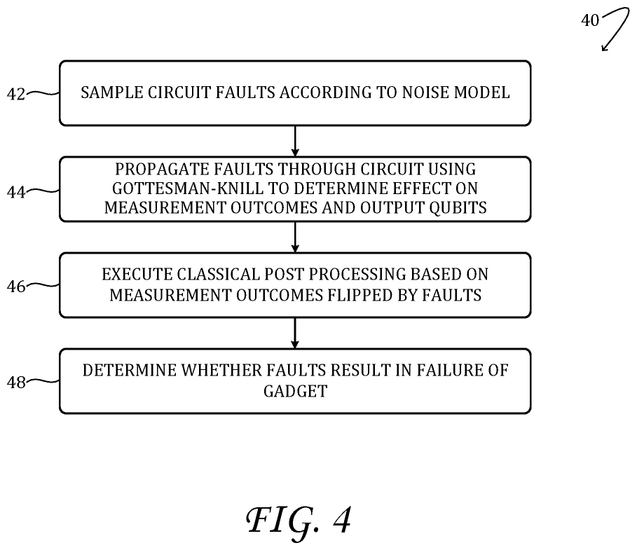

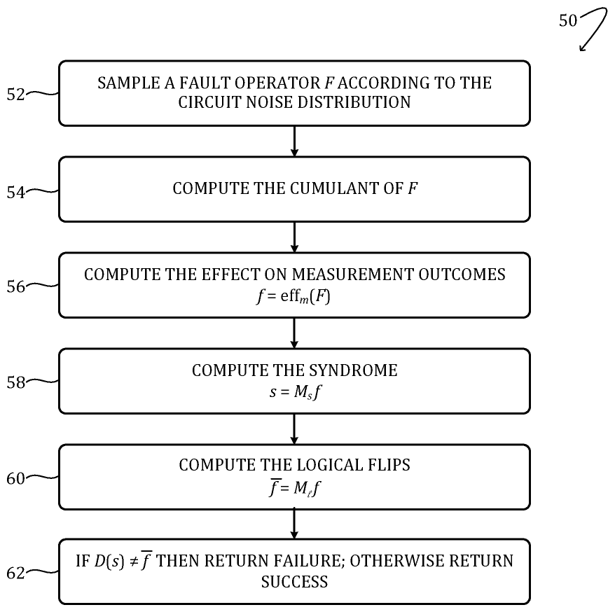

FIG. 4 is a high-level illustration of a comparative method 40 for estimating the performance of a Clifford circuit. At 42 of method 40, the circuit faults are sampled according to an acceptable noise model. At 44 the circuit faults are propagated through the circuit in the forward direction using Gottesman-Knill to determine the effect of each fault on the measurement outcome and on the output qubits. At 46 classical post-processing is executed based on the measurement outcomes flipped by the faults. At 48 a determination is made as to whether the faults have resulted in failure of the gadget.

The classical post-processing enacted at 48 may include computation of syndrome data, execution of a decoder, or computing parities of measurement outcomes, based on which the gadget may perform post selection. The simulation is typically repeated a very large number of times to generate enough data to obtain a good estimate of the failure rate. Say, for example, that the objective is to probe a three-parameter noise model. If only ten values for each noise parameter are selected, and if for each triple of values a billion samples are needed to reach a sufficiently small error bar for a corresponding data point, then the comparative method requires one trillion repetitions of the illustrated steps.

Typically the most costly aspects of method 40 are (i) running the decoder and (ii) propagating Pauli faults through the circuit. Low complexity decoders have been designed [Ref. 3][Ref. 7], and fast decoder implementations are available [Ref. 8][Ref. 9]. Proposed hereinafter is a simulation protocol that provides an equivalent estimate of the failure rate of a Clifford gadget with circuit noise, but without any forward fault propagation.

The idea is to leverage the spacetime-code structure of a Clifford circuit [Ref. 1]. More specifically, Proposition 3 from [Ref. 1](reviewed below in Proposition 1) allows the forward propagation of Pauli faults through a Clifford circuit to be replaced by a backward propagation of stabilizer generators of the spacetime code. As a result, instead of propagating faults trillions or times, the backward propagation of the spacetime generators can be precomputed—and need only be precomputed once. Similarly, the backward propagation of some logical operators may be precomputed to determine whether the protocol has succeeded or failed.

### 4. Clifford Circuits and Circuit Noise

This disclosure considers Clifford circuits comprised of unitary Clifford gates and measurements of Pauli operators. It follows the assumptions and notations of [Ref. 1], briefly reviewed as follows.

The circuit considered here acts on n qubits with depth Δ. Denote by [symbol] the set of n-qubit Pauli operators and by [symbol] its quotient relative to the phase operators {±I, ±iI}. A configuration of faults in the circuit is represented by a fault operator, which is a Pauli operator F∈ [symbol] acting on n(Δ+1) qubits. A fault operator can be represented as a Pauli operator acting on qubits placed on half-integer times steps of the circuit and indexed by pairs ( [symbol] +0.5, q) where [symbol] ∈{0, 1, . . . , Δ} is a level of the circuit and q∈{1, . . . , n} is a qubit. A circuit noise model for a circuit C is defined to be a probability distribution over the set of fault operators. Such a noise model includes both Pauli faults and measurement-outcome flips that can be represented by a Pauli error before and after the measurement.

It will be assumed that the circuit includes nₘ measurements. Each run of the circuit produces an outcome bit-string o∈{0, 1}ⁿ^{ₘ} whose ith component is the outcome of the ith measurement. Based on the outcome bit-string, a logical outcome [symbol] = [symbol] o∈ [symbol] is computed by applying a binary matrix [symbol] to o. The effect of a fault operator F is defined to be the pair eff(F)=(f, E) where f∈{0, 1}ⁿ^{ₘ} represents the measurement outcome flips induced by F and E∈ [symbol] is the residual error on the qubits at the end of the circuit when F occurs. Recall that fⱼ=1 iff F leads to a flip of the outcome of the jth measurement of the circuit. The notations effₘ(F)=f and eff_{q}(F)=E are used for the effect on measurement outcomes and the effect on qubits.

### 5. Correction of Circuit Faults Using the Outcome Code

[Ref. 1] proves that the outcome bit-string belongs to a linear code (up to a relabeling of the measurement outcomes), called the outcome code. This reference also explains how to correct circuit faults using the outcome code. That approach leads to a general correction protocol including a broad class of error-detecting and/or error-correcting quantum gadgets for stabilizer codes [Ref. 10], surface codes [Ref. 2][Ref. 3], color codes [Ref. 11] and Floquet codes [Ref. 4].

The correction of circuit faults based on the outcome code works as follows. After extracting the outcome bit-string o, its syndrome s=Mₛo∈{0, 1}ⁿ^{ₛ} is computed, where Mₛ is a binary matrix. The matrix Mₛ can be efficiently generated using Algorithm 1 of [Ref. 1]. In the absence of any circuit fault the syndrome is trivial. If faults corresponding to a fault operator F occur, the syndrome s=Mₛf is obtained, where f=effₘ(F)—a function depending only on F. In addition, F flips some logical outcomes; the indicator vector of the flipped logical bits is f̅=M [symbol] f.

A decoder D is used to correct the logical outcome of the circuit. The decoder takes as an input the syndrome s and returns a correction D(s)=f̅′ to apply to the logical outcome [symbol] i.e., by replacing [symbol] by [symbol] +f̅′. A failure occurs if the logical outcome [symbol] +f̅′ after decoding is incorrect due to the presence of faults in the execution of the circuit—that is, iff f̅′≠f̅. For simplicity, the focus herein is on failures to recover the logical outcome; the simulation protocol can be generalized, however, to failures induced by residual errors on the output qubits of the circuit. In that case, the decoder also applies a correction to the output qubits.

### 6. Circuit Noise Simulation Based on Fault Propagation

Presented now is a more detailed analysis of the comparative simulation protocol of FIG. 4, where circuit faults are propagated through the circuit in the forward direction.

Following [Ref. 1], denote by \vec{F} the cumulant of a fault operator F, which is the fault operator whose component [symbol] ∈ [symbol] , after level [symbol] is the result of all the faults occurring during the first [symbol] levels of the circuit propagated through the first [symbol] levels of unitary gates. The cumulant can be computed by conjugating faults through unitary gates using the standard stabilizer simulation algorithm [Ref. 10].

FIG. 5 is a high-level illustration of a comparative method 50 for simulating a Clifford circuit with circuit noise. Method 50 is a more detailed example of method 40 above. Accordingly, this method also may have to be repeated more than a trillion times. At 52 of method 50 a fault operator F is sampled according to the circuit noise distribution. At 54 the cumulant \vec{F} of the fault operator is computed. At 54 the effect on measurement outcomes f=effₘ(F) is computed. At 56 the syndrome s=Mₛf is computed. At 58 the logical flips f̅= [symbol] f are computed. At 60 of method 50, an indication of failure is returned if D(s)≠f̅; otherwise an indication of success is returned.

For simplicity, the computation of the cumulant \vec{F} and the computation of its effect f on measurement outcomes are separated. In practice, it is not necessary to compute the whole cumulant to obtain f. It is enough to compute the levels of the cumulant [symbol] sequentially, which reduces the memory cost of the simulation. In this disclosure, the memory cost is ignored because it is neither the bottleneck of the simulation nor a clear differentiator between the algorithms discussed.

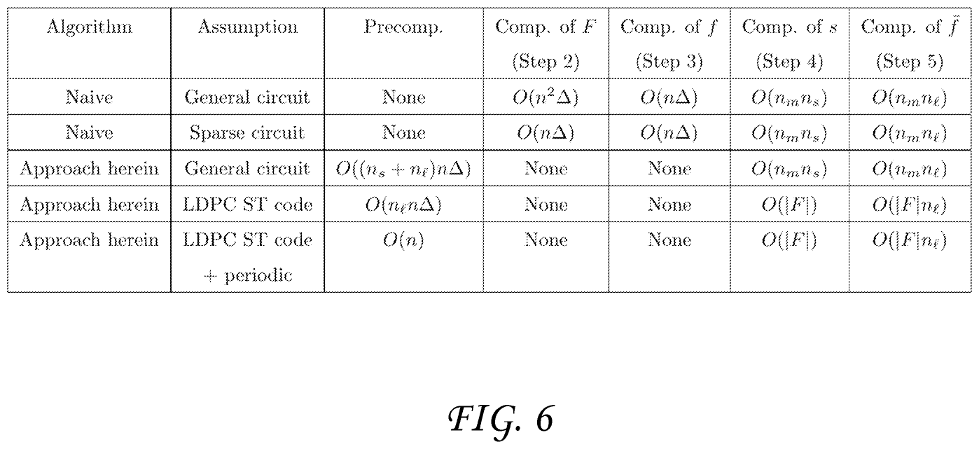

Suppose there is a fast decoder and consider the cost of the other steps of this simulation. The worst-case computational complexity of steps 54 through 60 is estimated in two settings: (i) for a general circuit and (ii) for a sparse circuit made with unitary gates and measurement supported on a bounded number of qubits. The worst-case complexity is computed as a function of the number of qubits n, the depth Δ, the number of measurements nₘ, the number of syndrome bits nₛ and the number of logical outcome bits [symbol] . Many noise models produce low-weight fault operators F. If that is the case, then some of the steps of the simulation can be accelerated. Therefore, the complexity as a function of the weight |F| of the fault operator sampled is also provided. The table of FIG. 6 summarizes the results.

More specifically, FIG. 6 illustrates the worst-case computational complexity of the main steps of the circuit-noise simulation for different classes of circuit and different simulation strategies. This disclosure considers general Clifford circuits, sparse Clifford circuits made with circuit operations acting on a bounded number of qubits, Clifford circuits with a LDPC spacetime (ST) code and periodic circuits with a LDPC ST code. The worst-case complexity is computed as a function of the number of qubits n, the circuit depth Δ, the number of measurements nₘ, the number of syndrome bits nₛ and the number of logical outcome bits [symbol] . In some cases, the approach herein provides a favorable complexity when the number of Pauli faults |F| in the circuit is small.

Considered first is the complexity of step 54 of method 50, the computation of \vec{F}. The comparative approach to compute the cumulant \vec{F} of F is by fault propagation. Assume that a unitary gate U acting on w qubits is represented by a 2w×2w binary matrix that stores the conjugation UPU⁻¹ of the Pauli operators P=X_{q} and Z_{q} acting on a qubit q of the support of U. Conjugating a general Pauli fault Q through this gate is equivalent to applying this matrix to the binary representation of the fault Q. This can be done in O(w²) operations. As a result, the worst-case computational complexity of the computation of the cumulant with this approach is O(n²Δ) bit operations for a general circuit (at most O(n²) per level). For a sparse circuit, the complexity drops to O(nΔ) bit operations. The computation of the cumulant of a low-weight fault operator with this method is not significantly faster because a single fault rapidly spreads to many qubits after propagating through a few levels of the circuit. Even though F is sparse, it is generally not the case for its cumulant.

Considered next is the complexity of step 56 of method 50, the computation of f. Given \vec{F}, the effect f=effₘ(F) can be obtained with a worst-case complexity of O(nΔ) bit operations for a general circuit. More precisely, the jth bit fⱼ of f is 1 iff the F induces a flip of the outcome of the jth measurement of the circuit. Let Sⱼ be the measured and let [symbol] be the level of this measurement. Then fⱼ is obtained as the commutator of [symbol] with the jth measured operator Sⱼ. This corresponds to Lemma 3 of [Ref. 1] which is included here because it is also used later in this disclosure. Recall that [symbol] (Sⱼ) is the fault operator obtained by placing the operator Sⱼ right before level [symbol] .

Lemma 1. (Lemma 3 of [Ref. 1]) Let F be a fault operator. The faults corresponding to F induce a flip of the measurement of Sⱼ iff [ [symbol] (Sⱼ)=1]. In other words, fⱼ=[\vec{F}, [symbol] (Sⱼ)].

The worst-case complexity of the computation of f remains unchanged for a sparse circuit or for a low-weight fault operator F because \vec{F} typically has large weight. For a general circuit, the computation of the syndrome s requires application of an nₘ×nₛ binary matrix to f, which can be done with a worst-case complexity of O(nₘnₛ). Again, this subroutine is not significantly faster for sparse circuits or for low-weight fault operators. Similarly, the computation of the logical flips \vec{f} can be done with a complexity of O(nₘ [symbol] ) bit operations in the worst case. However, the number of logical outcome bits [symbol] is often constant.

Putting things together, a worst-case complexity in O(n²Δ²) dominated by the syndrome computation is obtained. For some circuits, the syndrome and the logical flips can be computed more efficiently (in O(nΔ)), and then the worst-case complexity of the simulation is in O(n²Δ), or O(nΔ) for sparse circuits, dominated by the computation of the cumulant \vec{F} through fault propagation.

### 7. Circuit Noise Simulation without Forward Fault Propagation

For some specific circuits, such as the standard syndrome extraction circuit for surface codes, some of the steps of this simulation can be bypassed by directly computing the syndrome without fault propagation. This is because the standard surface-code circuit [Ref. 12] has a natural graph structure where each vertex corresponds to the measurement of an ancilla qubit in the circuit. That approach is less obvious for other surface code circuits like the measurement based circuits of [Ref. 13] or [Ref. 14], or for Floquet codes [Ref. 4]. In what follows, a general algorithm to perform circuit noise simulations without forward fault propagation is proposed. Also, the computation of the syndrome and the logical flips is simplified, resulting in a more favorable worst-case complexity for the simulation of arbitrary Clifford circuits, as shown in FIG. 6.

### 8. General Circuits

The key ingredient to avoiding forward fault propagation is the following result from [Ref. 1]. It relates the accumulator F [symbol] [symbol] and the back-accumulator F [symbol] [symbol] Recall that [symbol] is the fault operator defined in the same way as \vec{F} but by propagating faults backward through the unitary gates of the circuit.

Proposition 1. (Proposition 3 of [Ref. 1]) For all fault operators F, G of a circuit [symbol] ,

$$[ \vec{F} , G ] = [ F , ] . \qquad ( 6 )$$

For any vector u∈{0, 1}ⁿ^{ₘ}, define the operator

$$F ( u ) = {\prod }_{j = 1}^{{n}_{m}} {η}_{{ℓ}_{j} - 0.5} ( {S}_{j}^{{u}_{j}} ) , \qquad ( 7 )$$

also used in [Ref. 1]. Therein, Sⱼ is the jth measured operator and [symbol] is the level of the circuit at which this operator is measured. With this notation, Proposition [symbol] leads to the following result.

Corollary 1. Let F be a fault operator with effect f=effₘ(F) on measurement outcomes. If u∈{0, 1}ⁿ^{ₘ}, then

$$( f \vert u ) = [ F , ] . \qquad ( 8 )$$

Therein (x|y)=Σᵢ xᵢ yⱼ (mod 2), the standard binary inner product between two binary vectors.

Proof By Lemma [symbol] , fⱼ=[\vec{F}, [symbol] (Sⱼ)]. Using the standard properties of the commutator (see Section 3.3 of [Ref. 1]),

$$\begin{matrix}( u \vert f ) = {u}_{j} {f}_{j} \\ = {\sum }_{j = 1}^{{n}_{m}} {u}_{j} [ \vec{F} , {η}_{{ℓ}_{j} - 0.5} ( {S}_{j} ) ] \\ = {\sum }_{j = 1}^{{n}_{m}} [ \vec{F} , {η}_{{ℓ}_{j} - 0.5} ( {S}_{j}^{{u}_{j}} ) ] \\ = [ \vec{F} , {\prod }_{j = 1}^{{n}_{m}} {η}_{{ℓ}_{j} - 0.5} ( {S}_{j}^{{u}_{j}} ) ] \\ = [ \vec{F} , F ( u ) ] ,\end{matrix} \qquad ( 9 )$$

and applying Proposition [symbol] , [F, [symbol] ] is reached.

By definition, any bit b of s or f̅ can be written as b=(u|f) for some vector u∈{0, 1}ⁿ^{ₘ}, where u is a row of Mₛ or [symbol] . As a result, one can directly compute any bit of s or f̅ without fault propagation and even without computing f. Instead, [symbol] is precomputed for each of the nₛ+ [symbol] rows of the matrices Mₛ and [symbol] . The worst-case complexity of this precomputation grows as O((nₛ+ [symbol] )n²Δ) for a general Clifford circuit and is O((nₛ+ [symbol] )nΔ) for a sparse circuit. Once the precomputation is done, each syndrome bit is obtained by computing a commutator with an operator [symbol] acting on at most n(Δ+1) qubits.

With this approach, the cost of the computation of \vec{F} and f is removed and the worst-case complexity of computing s and f remains, respectively, O(nₘnₛ) and O(nₘ [symbol] ) bit operations.

### 9. LDPC Spacetime Code

Assume now that the spacetime code of the circuit is LDPC. Recall that the spacetime code is defined by the stabilizer generators [symbol] used to compute the syndrome bits [Ref. 1]. Because this code is LDPC, each qubit belongs to at most O(1) of the operators [symbol] used to compute s. Then, s can be computed using the relation of eq 8 in O(|F|) bit operations in the worst case. The same argument does not apply to the computation of the bits of f̅ because the corresponding back-accumulated operator can have large weight; [symbol] is often a small constant, however, making the computation of f̅ inexpensive. If in addition the circuit simulated is obtained by repeating a constant depth circuit periodically, then the precomputation of the operators [symbol] used to compute s and f̅ can be done in O(n) bit operations.

This procedure does not include the generation of a set of checks defining the syndrome map f [symbol] s in the cost of the precomputation. An algorithm for this is described in [Ref. 1]. For general circuit, it runs in O(n⁴Δ) bits operations. Its complexity is reduced to O(nΔ) for LDPC spacetime codes and O(n) for periodic LDPC spacetime codes.

### 10. Illustration of New Simulation Method

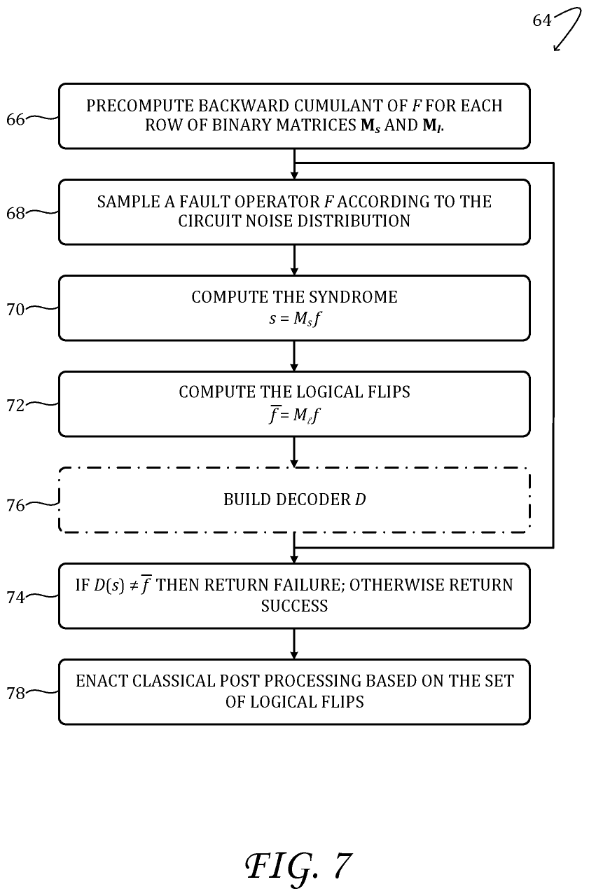

Based on the explanation above, FIG. 7 shows aspects of an example method 64 to forecast a result of a Clifford circuit acting on a plurality of qubits of a quantum computer, where the Clifford circuit is subject to noise.

At 66 of method 64 a classical computer system precomputes the backward cumulant [symbol] of the fault operator F acting on the plurality of qubits according to a predetermined noise distribution. The backward cumulant is computed for each row u of binary matrices Mₛ and Mₗ according to the Clifford circuit and the fault operator. It reflects the effect f=effₘ(F) on measurement outcomes of the plurality of qubits.

Binary matrix Mₛ is a table of numbers where each row of the table is an ordered array of bits (0 or 1) indicating the measurement outcomes corresponding to a given syndrome bit. Mₛ has one column for each measurement outcome of the circuit and one row for each sample. Binary matrix Mₗ is a table of numbers where each row of the table is an ordered array of bits (0 or 1) corresponding to a given logical outcome bit. Mₗ has one column for each measurement outcome of the circuit and one row for each logical outcome bit. The matrix tables may be stored in any appropriate data structure of a classical computer system.

The origin of binary matrices Mₛ and Mₗ is not particularly limited. In some examples each of the binary matrices may be provided as an input—i.e., as part of the description of the error correction scheme. In other examples, the input may comprise only the Clifford circuit and Mₛ and Mₗ may be computed using the algorithms of [Ref. 1]. More specifically, the syndrome matrix Mₛ may be obtained from Algorithms 1 and 3 of [Ref. 1]. Alternative algorithms also may be used. Likewise, logical matrix Mₗ may either be provided as input or by the logical operators at the end of the Clifford circuit. In some examples, Mₗ can be computed by propagation of a logical basis through the whole circuit using the Gottesman-Knill algorithm.

At 68 the classical computer system samples the fault operator F for the plurality of qubits according to the predetermined noise distribution in the Clifford circuit. Typically the fault operator is sampled repeatedly. For each sample a bit of the syndrome is computed for each row of Mₛ and the set of logical flips is computed for each row of Mₗ. At 70 the classical computer system computes a syndrome s=Mₛf corresponding to the effect based on the commutator of the backward cumulant [symbol] versus a row of the binary matrix Mₛ. In some examples a bit of the syndrome is computed for each row of Mₛ—e.g., iteratively. At 72 the classical computer system computes a set of logical flips f̅=Mₗf corresponding to the effect based on the commutator of the backward cumulant [symbol] versus a row of the binary matrix Mₗ. In some examples the set of logical flips is computed for each row of Mₗ—e.g., iteratively. At 74 the classical computer system returns the result based on the syndrome and on the set of logical flips. At optional step 76 a classical computer system builds a decoder D(s), which maps each syndrome s to a corresponding correction. In that variant of method 64 returning the result includes, at 74, returning an indication of failure when D(s)≠f̅ and returning an indication of success when D(s)=f̅. At optional step 78 a classical computer system enacts classical post-processing based on the set of logical flips f̅. In some examples, such post-processing may include operation of a decoder, such as a decoder built at optional step 76 or any other compatible decoder.

The nature of the Clifford circuit used in connection with method 64 is not particularly limited. In some examples the Clifford circuit equates to a low-density parity-check (LDPC) spacetime code. In some examples the Clifford circuit comprises a repeated, constant-depth circuit. Advantageously, in some examples the syndrome and the set of logical flips are computed without explicit computation of a forward cumulant \vec{F} of the fault operator. In some examples the syndrome and the set of logical flips are computed without explicit computation of the effect f=effₘ(F).

No aspect of the drawings or description should be interpreted in a limiting sense, because numerous variations, extensions, and omissions are also envisaged. For instance, some aspects of the comparative solutions illustrated in FIGS. 4 and 5 may be used to an advantage in the method of FIG. 7, in some examples.

### 11. References, Classical-Computer Description, and Conclusion

The interested reader is referred to the following publications, which are hereby incorporated herein by reference for all purposes.
[Ref. 1] Nicolas Delfosse and Adam Paetznick, “Spacetime codes of Clifford circuits” arXiv preprint arXiv:2304.05943 (2023).
[Ref. 2] Eric Dennis, Alexei Kitaev, Andrew Landahl, and John Preskill, “Topological quantum memory” Journal of Mathematical Physics 43:9, 4452-4505 (2002).
[Ref. 3] Austin G. Fowler, Matteo Mariantoni, John M. Martinis, and Andrew N. Cleland, “Surface codes: Towards practical large-scale quantum computation” Physical Review A 86:3, 032324 (2012).
[Ref. 4] Matthew B. Hastings and Jeongwan Haah, “Dynamically generated logical qubits” Quantum 5, 564 (2021).
[Ref. 5] Adam Paetznick, Christina Knapp, Nicolas Delfosse, Bela Bauer, Jeongwan Haah, Matthew B. Hastings, and Marcus P. da Silva, “Performance of planar Floquet codes with Majorana-based qubits” PRX Quantum 4:1, 010310 (2023).
[Ref. 6] Craig Gidney, Michael Newman, and Matt McEwen, “Benchmarking the planar honeycomb code” Quantum 6, 813 (2022).
[Ref. 7] Nicolas Delfosse and Naomi H. Nickerson, “Almost-linear time decoding algorithm for topological codes” Quantum 5, 595 (2021).
[Ref. 8] Oscar Higgott and Craig Gidney, “Sparse Blossom: correcting a million errors per core second with minimum-weight matching” arXiv preprint arXiv:2303.15933 (2023).
[Ref. 9] Yue Wu and Lin Zhong, “Fusion Blossom: Fast MWPM Decoders for QEC” arXiv preprint arXiv:2305.08307 (2023).
[Ref. 10] Daniel Gottesman, “Stabilizer codes and quantum error correction” California Institute of Technology (1997).
[Ref. 11] Hector Bombin and Miguel Angel Martin-Delgado, “Topological quantum distillation” Physical review letters 97:18, 180501 (2006).
[Ref. 12] Yu Tomita and Krysta M. Svore, “Low-distance surface codes under realistic quantum noise” Physical Review A 90:6, 062320 (2014).
[Ref. 13] Rui Chao, Michael E. Beverland, Nicolas Delfosse, and Jeongwan Haah, “Optimization of the surface code design for Majorana-based qubits” Quantum 4, 352 (2020).
[Ref. 14] Craig Gidney, “A Pair Measurement Surface Code on Pentagons” arXiv preprint arXiv:2206.12780 (2022).

The methods herein may be tied to a computer system of one or more computing devices. Such methods and processes may be implemented as an application program or service, an application programming interface (API), a library, and/or other computer-program product.

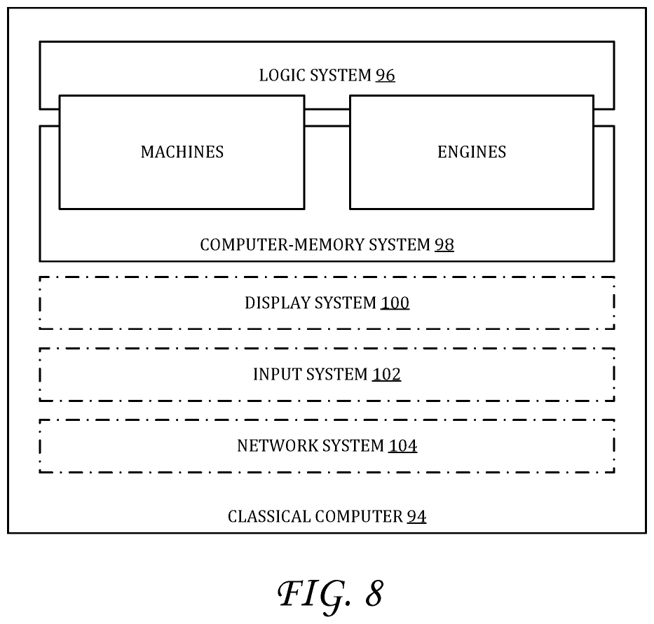

FIG. 8 provides a schematic representation of a classical computer 94 configured to provide some or all of the classical computer system functionality disclosed herein. Classical computer 94 may take the form of a personal computer, application-server computer, or any other computing device.

Classical computer 94 includes a logic system 96 and a computer-memory system 98. Classical computer 94 may optionally include a display system 100, an input system 102, a network system 104, and/or other systems not shown in the drawings.

Logic system 96 includes one or more physical devices configured to execute instructions. For example, the logic system may be configured to execute instructions that are part of at least one operating system (OS), application, service, and/or other program construct. The logic system may include at least one hardware processor (e.g., microprocessor, central processor, central processing unit (CPU) and/or graphics processing unit (GPU)) configured to execute software instructions. Additionally or alternatively, the logic system may include at least one hardware or firmware device configured to execute hardware or firmware instructions. A processor of the logic system may be single-core or multi-core, and the instructions executed thereon may be configured for sequential, parallel, and/or distributed processing. Individual components of the logic system optionally may be distributed among two or more separate devices, which may be remotely located and/or configured for coordinated processing. Aspects of the logic system may be virtualized and executed by remotely-accessible, networked computing devices configured in a cloud-computing configuration.

Computer-memory system 98 includes at least one physical device configured to temporarily and/or permanently hold computer system information, such as data and instructions executable by logic system 96. When the computer-memory system includes two or more devices, the devices may be collocated or remotely located. Computer-memory system 98 may include at least one volatile, nonvolatile, dynamic, static, read/write, read-only, random-access, sequential-access, location-addressable, file-addressable, and/or content-addressable computer-memory device. Computer-memory system 98 may include at least one removable and/or built-in computer-memory device. When the logic system executes instructions, the state of computer-memory system 98 may be transformed—e.g., to hold different data.

Aspects of logic system 96 and computer-memory system 98 may be integrated together into one or more hardware-logic components. Any such hardware-logic component may include at least one program- or application-specific integrated circuit (PASIC/ASIC), program- or application-specific standard product (PSSP/ASSP), system-on-a-chip (SOC), or complex programmable logic device (CPLD), for example.

Logic system 96 and computer-memory system 98 may cooperate to instantiate one or more logic machines or engines. As used herein, the terms ‘machine’ and ‘engine’ each refer collectively to a combination of cooperating hardware, firmware, software, instructions, and/or any other components that provide computer system functionality. In other words, machines and engines are never abstract ideas and always have a tangible form. A machine or engine may be instantiated by a single computing device, or a machine or engine may include two or more subcomponents instantiated by two or more different computing devices. In some implementations, a machine or engine includes a local component (e.g., a software application executed by a computer system processor) cooperating with a remote component (e.g., a cloud computing service provided by a network of one or more server computer systems). The software and/or other instructions that give a particular machine or engine its functionality may optionally be saved as one or more unexecuted modules on one or more computer-memory devices.

Machines and engines may be implemented using any suitable combination of machine learning (ML) and artificial intelligence (AI) techniques. Non-limiting examples of techniques that may be incorporated in an implementation of one or more machines include support vector machines, multi-layer neural networks, convolutional neural networks (e.g., spatial convolutional networks for processing images and/or video, and/or any other suitable convolutional neural network configured to convolve and pool features across one or more temporal and/or spatial dimensions), recurrent neural networks (e.g., long short-term memory networks), associative memories (e.g., lookup tables, hash tables, bloom filters, neural Turing machines and/or neural random-access memory) unsupervised spatial and/or clustering methods (e.g., nearest neighbor algorithms, topological data analysis, and/or k-means clustering), and/or graphical models (e.g., (hidden) Markov models, Markov random fields, (hidden) conditional random fields, and/or AI knowledge bases)).

When included, display system 100 may be used to present a visual representation of data held by computer-memory system 98. The visual representation may take the form of a graphical user interface (GUI) in some examples. The display system may include one or more display devices utilizing virtually any type of technology. In some implementations, display system may include one or more virtual-, augmented-, or mixed reality displays.

When included, input system 102 may comprise or interface with one or more input devices. An input device may include a sensor device or a user input device. Examples of user input devices include a keyboard, mouse, or touch screen.

When included, network system 104 may be configured to communicatively couple classical computer 94 with one or more other computer systems. The network system may include wired and/or wireless communication devices compatible with one or more different communication protocols. The network system may be configured for communication via personal-, local- and/or wide-area networks.

In conclusion, one aspect of this disclosure is directed to a method to forecast a result of a Clifford circuit acting on a plurality of qubits of a quantum computer, the Clifford circuit being subject to noise. The method comprises: (a) for a fault operator F acting on the plurality of qubits according to a predetermined noise distribution, precomputing a backward cumulant [symbol] of the fault operator for each row u of binary matrices Mₛ and Mₗ, the backward cumulant reflecting an effect f=effₘ(F) on measurement outcomes of the plurality of qubits according to the Clifford circuit and the fault operator; (b) sampling the fault operator F for the plurality of qubits according to the predetermined noise distribution in the Clifford circuit; (c) computing a syndrome s=Mₛf corresponding to the effect based on a commutator of the backward cumulant [symbol] versus a row of the binary matrix Mₛ; (d) computing a set of logical flips f̅=Mₗf corresponding to the effect based on a commutator of the backward cumulant [symbol] versus a row of the binary matrix Mₗ; and (e) returning the result based on the syndrome and on the set of logical flips.

In some implementations the fault operator is sampled repeatedly, and for each sample a bit of the syndrome is computed for each row of Mₛ and the set of logical flips is computed for each row of Mₗ. In some implementations the method further comprises applying a decoder D(s) which maps each syndrome s to a corresponding correction, and returning the result includes: returning an indication of success when D(s)=f̅; and returning an indication of failure when D(s)≠f̅. In some implementations the method further comprises classical post-processing based on the set of logical flips f̅. In some implementations the Clifford circuit equates to a low-density parity-check (LDPC) spacetime code. In some implementations the Clifford circuit comprises a repeated, constant-depth circuit. In some implementations the syndrome and the set of logical flips are computed without explicit computation of a forward cumulant \vec{F} of the fault operator. In some implementations the syndrome and the set of logical flips are computed without explicit computation of the effect f=effₘ(F).

Another aspect of this disclosure is directed to a quantum computer comprising a qubit register with a plurality of physical qubits; an interface configured to measure each of the plurality of qubits, to thereby reveal a quantum state held in the qubit register; and a controller coupled operatively to the interface and configured to direct the measurement according to a spacetime quantum code supporting quantum error correction, the spacetime quantum code qualified by: (a) for a fault operator F acting on the plurality of qubits according to a predetermined noise distribution, precomputing a backward cumulant [symbol] of the fault operator for each row u of binary matrices Mₛ and Mₗ, the backward cumulant reflecting an effect f=effₘ(F) on measurement outcomes of the plurality of qubits according to the Clifford circuit and the fault operator; (b) sampling the fault operator F for the plurality of qubits according to the predetermined noise distribution in the Clifford circuit; (c) computing a syndrome s=Mₛf corresponding to the effect based on a commutator of the backward cumulant [symbol] versus a row of the binary matrix Mₛ; (d) computing a set of logical flips f̅=Mₗf corresponding to the effect based on a commutator of the backward cumulant [symbol] versus a row of the binary matrix Mₗ; and (e) returning the result based on the syndrome and on the set of logical flips.

In some implementations the controller is further configured to apply a decoder D(s) which maps each syndrome s to a corresponding correction, and returning the result includes: returning an indication of success when D(s)=f̅; and returning an indication of failure when D(s)≠f̅. In some implementations the Clifford circuit equates to a low-density parity-check (LDPC) spacetime code. In some implementations the Clifford circuit comprises a repeated, constant-depth circuit. In some implementations the syndrome and the set of logical flips are computed without explicit computation of a forward cumulant \vec{F} of the fault operator. In some implementations the syndrome and the set of logical flips are computed without explicit computation of the effect f=effₘ(F).

Another aspect of this disclosure is directed to a method for operating a quantum computer. The method comprises supplying an error-correcting spacetime code to a controller coupled operatively to a qubit interface of the quantum computer, the spacetime code being qualified by: (a) for a fault operator F acting on the plurality of qubits according to a predetermined noise distribution, precomputing a backward cumulant [symbol] of the fault operator for each row u of binary matrices Mₛ and Mₗ, the backward cumulant reflecting an effect f=effₘ(F) on measurement outcomes of the plurality of qubits according to the Clifford circuit and the fault operator; (b) sampling the fault operator F for the plurality of qubits according to the predetermined noise distribution in the Clifford circuit; (c) computing a syndrome s=Mₛf corresponding to the effect based on a commutator of the backward cumulant [symbol] versus a row of the binary matrix Mₛ; (d) computing a set of logical flips f̅=Mₗf corresponding to the effect based on a commutator of the backward cumulant [symbol] versus a row of the binary matrix Mₗ; and (e) returning the result based on the syndrome and on the set of logical flips.

In some implementations the method further comprises applying a decoder D(s) which maps each syndrome s to a corresponding correction, and returning the result includes: returning an indication of success when D(s)=f̅; and returning an indication of failure when D(s)≠f̅. In some implementations the Clifford circuit equates to a low-density parity-check (LDPC) spacetime code. In some implementations the Clifford circuit comprises a repeated, constant-depth circuit. In some implementations the syndrome and the set of logical flips are computed without explicit computation of a forward cumulant \vec{F} of the fault operator. In some implementations the syndrome and the set of logical flips are computed without explicit computation of the effect f=effₘ(F).

This disclosure is presented by way of example and with reference to the attached drawing figures. Components, process steps, and other elements that may be substantially the same in one or more of the figures are identified coordinately and described with minimal repetition. It will be noted, however, that elements identified coordinately may also differ to some degree. It will be further noted that the figures are schematic and generally not drawn to scale. Rather, the various drawing scales, aspect ratios, and numbers of components shown in the figures may be purposely distorted to make certain features or relationships easier to see. The plots shown in the drawings are theoretical unless otherwise noted.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed. In that spirit, the phrase ‘based at least partly on’ is intended to remind the reader that the functional and/or conditional logic illustrated herein neither requires nor excludes suitable additional logic, executing in combination with the illustrated logic, to provide additional benefits.

The subject matter of the present disclosure includes all novel and non-obvious combinations and sub-combinations of the various processes, systems and configurations, and other features, functions, acts, and/or properties disclosed herein, as well as any and all equivalents thereof.

1. A method to forecast a result of a Clifford circuit acting on a plurality of qubits of a quantum computer, the Clifford circuit being subject to noise, the method comprising:
for a fault operator F acting on the plurality of qubits according to a predetermined noise distribution, precomputing a backward cumulant [symbol] of the fault operator for each row u of binary matrices Mₛ and Mₗ, the backward cumulant reflecting an effect f=effₘ(F) on measurement outcomes of the plurality of qubits according to the Clifford circuit and the fault operator;
sampling the fault operator F for the plurality of qubits according to the predetermined noise distribution in the Clifford circuit;
computing a syndrome s=Mₛf corresponding to the effect based on a commutator of the backward cumulant [symbol] versus a row of the binary matrix Mₛ;
computing a set of logical flips f̅=Mₗf corresponding to the effect based on a commutator of the backward cumulant [symbol] versus a row of the binary matrix Mₗ; and
returning the result based on the syndrome and on the set of logical flips.

2. The method of claim 1 wherein the fault operator is sampled repeatedly, and for each sample a bit of the syndrome is computed for each row of Mₛ and the set of logical flips is computed for each row of Mₗ.

3. The method of claim 1 further comprising applying a decoder D(s) which maps each syndrome s to a corresponding correction, wherein returning the result includes:
returning an indication of success when D(s)=f̅; and
returning an indication of failure when D(s)≠f̅.

4. The method of claim 1 further comprising classical post-processing based on the set of logical flips f̅.

5. The method of claim 1 wherein the Clifford circuit equates to a low-density parity-check (LDPC) spacetime code.

6. The method of claim 1 wherein the Clifford circuit comprises a repeated, constant-depth circuit.

7. The method of claim 1 wherein the syndrome and the set of logical flips are computed without explicit computation of a forward cumulant \vec{F} of the fault operator.

8. The method of claim 1 wherein the syndrome and the set of logical flips are computed without explicit computation of the effect f=effₘ(F).

9. A quantum computer comprising:
a qubit register with a plurality of physical qubits;
an interface configured to measure each of the plurality of qubits, to thereby reveal a quantum state held in the qubit register; and
a controller coupled operatively to the interface and configured to direct the measurement according to a spacetime quantum code supporting quantum error correction, the spacetime quantum code qualified by:
for a fault operator F acting on the plurality of qubits according to a predetermined noise distribution, precomputing a backward cumulant [symbol] of the fault operator for each row u of binary matrices Mₛ and Mₗ, the backward cumulant reflecting an effect f=effₘ(F) on measurement outcomes of the plurality of qubits according to the Clifford circuit and the fault operator;
sampling the fault operator F for the plurality of qubits according to the predetermined noise distribution in the Clifford circuit;
computing a syndrome s=Mₛf corresponding to the effect based on a commutator of the backward cumulant [symbol] versus a row of the binary matrix Mₛ;
computing a set of logical flips f̅=Mₗf corresponding to the effect based on a commutator of the backward cumulant [symbol] versus a row of the binary matrix Mₗ; and
returning the result based on the syndrome and on the set of logical flips.

10. The quantum computer of claim 9 wherein the controller is further configured to apply a decoder D(s) which maps each syndrome s to a corresponding correction, wherein returning the result includes:
returning an indication of success when D(s)=f̅; and
returning an indication of failure when D(s)≠f̅.

11. The quantum computer of claim 9 wherein the Clifford circuit equates to a low-density parity-check (LDPC) spacetime code.

12. The quantum computer of claim 9 wherein the Clifford circuit comprises a repeated, constant-depth circuit.

13. The quantum computer of claim 9 wherein the syndrome and the set of logical flips are computed without explicit computation of a forward cumulant F of the fault operator.

14. The quantum computer of claim 9 wherein the syndrome and the set of logical flips are computed without explicit computation of the effect f=effₘ(F).

15. A method for operating a quantum computer, the method comprising:
supplying an error-correcting spacetime code to a controller coupled operatively to a qubit interface of the quantum computer, the spacetime code being qualified by:
for a fault operator F acting on the plurality of qubits according to a predetermined noise distribution, precomputing a backward cumulant [symbol] of the fault operator for each row u of binary matrices Mₛ and Mₗ, the backward cumulant reflecting an effect f=effₘ(F) on measurement outcomes of the plurality of qubits according to the Clifford circuit and the fault operator;
sampling the fault operator F for the plurality of qubits according to the predetermined noise distribution in the Clifford circuit;
computing a syndrome s=Mₛf corresponding to the effect based on a commutator of the backward cumulant [symbol] versus a row of the binary matrix Mₛ;
computing a set of logical flips f̅=Mₗf corresponding to the effect based on a commutator of the backward cumulant [symbol] versus a row of the binary matrix Mₗ; and
returning the result based on the syndrome and on the set of logical flips.

16. The method of claim 15 further comprising applying a decoder D(s) which maps each syndrome s to a corresponding correction, wherein returning the result includes:
returning an indication of success when D(s)=f̅; and
returning an indication of failure when D(s)≠f̅.

17. The method of claim 15 wherein the Clifford circuit equates to a low-density parity-check (LDPC) spacetime code.

18. The method of claim 15 wherein the Clifford circuit comprises a repeated, constant-depth circuit.

19. The method of claim 15 wherein the syndrome and the set of logical flips are computed without explicit computation of a forward cumulant \vec{F} of the fault operator.

20. The method of claim 15 wherein the syndrome and the set of logical flips are computed without explicit computation of the effect f=effₘ(F).
